(19) United States
(12) Patent Application Publication
(10) Pub. No.: US 2025/0004516 A1
(43) Pub. Date: Jan. 2, 2025

(54) Mitigation Of Undershoot And Overshoot On A Power Rail

(71) Applicants: Advanced Micro Devices, Inc., Santa Clara, CA (US); ATI Technologies ULC, Markham (CA)

(72) Inventors: Josip Popovic, Markham (CA); Anshuman Mittal, Santa Clara, CA (US); Kellie Marks, Sydney (AU)

(21) Appl. No.: 18/346,070

(22) Filed: Jun. 30, 2023

(51) Int. Cl. G06F 1/26

(52) U.S. Cl. CPC G06F 1/26

(57) ABSTRACT

An apparatus and method for efficiently managing voltage droop among replicated compute circuits of an integrated circuit. In various implementations, an integrated circuit includes multiple, replicated compute circuits, each with the circuitry of multiple lanes of execution. Control circuitry of the integrated circuit identifies, early in execution pipelines, groups of instructions to be executed by a corresponding compute circuit, and generates a total power consumption estimate for the groups. The control circuitry maintains N previous total power consumption estimates, and stores the N power consumption estimates in staging circuitry referred to as an “instruction history pipeline.” If any differences between total power consumption estimates of different stages of the instruction history pipeline exceeds a corresponding threshold, then the control circuitry reduces, late in the execution pipeline, the rate of instruction execution of computation lanes of a corresponding compute circuit.

### BACKGROUND

### Description of the Relevant Art

Voltage droop of modern integrated circuits has become an increasing design issue with each generation of semiconductor chips. Parasitic inductance increases transmission line effects on a chip such as ringing and reduced propagation delays. Also, a simultaneous switching of a wide bus causes a significant voltage droop if a shared power rail corresponding to a voltage supply pin served all of the line buffers on the bus. The voltage transient associated with the voltage droop can be positive or negative, and this voltage droop, ΔV, is proportional to the expression L di/dt, with L being the parasitic inductance and di/dt being the time rate of change of the current consumption. The resulting voltage droop can be positive or negative, since there are two directions for the time rate of change of the current consumption, di/dt, corresponding to the shared power rail.

The current can be drawn from the power rail during the near simultaneous charging of a large number of nodes, even nodes other than nodes of buses, of the integrated circuit. Suddenly drawing away a large amount of the power supply current from the shared power rail causes a condition referred to as “undershoot.” The time rate of change of the current consumption, di/dt, is positive and large, which increases the voltage droop, ΔV. The voltage droop, ΔV, is the difference between the initial voltage and the final voltage of the shared power rail. Therefore, the difference, ΔV, is a large positive value, and the final voltage is less than the initial voltage of the shared power rail. The power supply voltage level on the power rail reduces as the amount of power supply current being drawn from the shared power rail suddenly increases. When undershoot occurs, the switching speeds of devices reduce, which reduces performance. The operating clock frequency needs to reduce to allow the setup time to be satisfied of sequential elements.

The near simultaneous discharging of a large number of nodes, even nodes other than nodes of buses, of the integrated circuit can also return a large amount of the power supply current to the shared power rail. Suddenly returning a large amount of the power supply current to the shared power rail causes a condition referred to as “overshoot.” The time rate of change of the current consumption, di/dt, is negative and large, which decreases the voltage droop, ΔV. The voltage droop, ΔV, is the difference between the initial voltage and the final voltage of the shared power rail. Therefore, the difference, ΔV, is a large negative value, and the final voltage is greater than the initial voltage. The power supply voltage level on the power rail increases as the amount of power supply current being returned to the shared power rail suddenly increases. When overshoot occurs, the switching speeds of devices increase, which increases performance. However, the operating clock frequency needs to increase to allow the hold time to be satisfied of sequential elements. The overshoot condition occurs when there is negative voltage droop, and the undershoot condition occurs when there is positive voltage droop. The resulting voltage transients include both a positive voltage droop and a negative voltage droop. The undershoot and overshoot conditions are not only an issue for portable computers and mobile communication devices, but also for high-performance superscalar microprocessors.

To reduce the effects of voltage droop, such as the undershoot and overshoot conditions, some integrated circuits reduce the operational clock frequency. However, the performance decreases. Another manner to reduce the voltage droop is placing one or more of an external capacitor between the supply leads and an on-chip capacitor between the internal supply leads. Each of these capacitances create a passive bypass that reduces the supply line oscillation due to one of external or internal inductances, but not both of the inductances. In addition, However, the internal capacitor is very large, which requires a significant portion of the chip area. This manner is undesirable when minimization of the die area is needed.

In view of the above, methods and systems for efficiently managing the overshoot condition and the undershoot condition of an integrated circuit are desired.

### BRIEF DESCRIPTION OF THE DRAWINGS

FIG. 1 is a generalized block diagram of an apparatus that manages the overshoot condition and the undershoot condition among replicated compute circuits of an integrated circuit.

FIG. 2 is a generalized block diagram of signal waveforms that illustrates voltage droops (positive or negative) of a power supply reference level of an integrated circuit.

FIG. 3 is a generalized block diagram of signal waveforms that illustrates voltage droops (positive or negative) of a power supply reference level of an integrated circuit.

FIG. 4 is a generalized block diagram of signal waveforms that illustrates voltage droops (positive or negative) of a power supply reference level of an integrated circuit.

FIG. 5 is a generalized block diagram of an apparatus that manages the overshoot condition and the undershoot condition among replicated compute circuits of an integrated circuit.

FIG. 6 is a generalized block diagram of control circuitry that efficiently manages the overshoot condition and the undershoot condition of multiple compute circuits.

FIG. 7 is a generalized block diagram of an apparatus that manages the overshoot condition and the undershoot condition among replicated compute circuits of an integrated circuit.

FIG. 8 is a generalized block diagram of a method for efficiently managing the overshoot condition and the undershoot condition of multiple compute circuits of an integrated circuit.

FIG. 9 is a generalized block diagram of computing system that efficiently manages the overshoot condition and the undershoot condition of multiple compute circuits of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently managing voltage droop of multiple compute circuits of an integrated circuit are contemplated. In various implementations, an integrated circuit includes multiple, replicated compute circuits, each with the circuitry of multiple lanes of execution. The integrated circuit also includes control circuitry that changes the rate of instruction execution of the computation lanes located at the end of the hardware execution pipelines. The change of the rate of instruction execution is based on a prediction of a time rate of change of the delivery of current, di/dt, from a power rail. To determine this prediction, the control circuitry monitors the instruction types of instructions, such as the opcodes of instructions, at the start of the execution pipelines.

The control circuitry identifies, early in the execution pipeline of a compute circuit, such as at the start of the execution pipeline, a group of one or more instructions to be executed by the computation lanes located at the end of the hardware execution pipelines of the compute circuit. The control circuitry generates a total power consumption estimate for the group. Additionally, the control circuitry generates a second total power consumption estimate by accumulating power consumption estimates of each of the multiple compute circuits. Further, the control circuitry maintains N previous power consumption estimates of the multiple compute circuits, wherein N is a positive, non-zero integer. The control circuitry stores the N power consumption estimates in stage circuitry referred to as an “instruction history pipeline.” Each of the N stages of the instruction history pipeline stores a respective one of the N previous power consumption estimates of the multiple compute circuits.

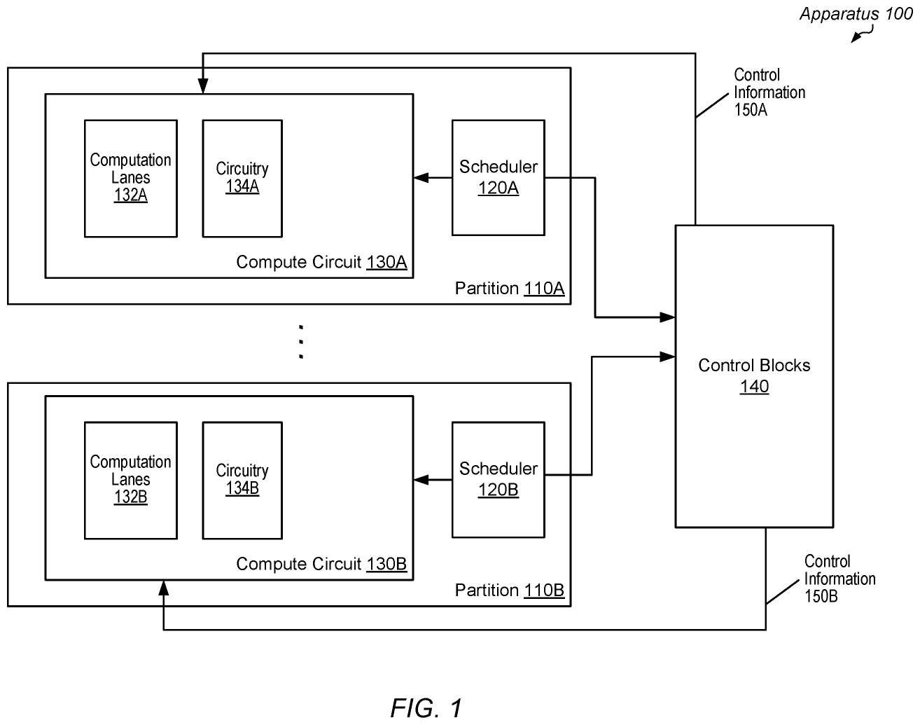

In an implementation, the control circuitry determines one or more difference values where a single difference value is determined by comparing two power consumption estimates of two different stages of the N stages of the instruction history pipeline. In another implementation, the control circuitry uses a formula to determine the one or more difference values. In one implementation, prior to comparing two power consumption estimates of two different stages of the N stages, the control circuitry, using the formula, multiplies the power consumption estimates by weights, and the weights are based on the corresponding stage of the N stages of the instruction history pipeline. In other implementations, the control circuitry uses another type of formula to determine the difference values. If the control circuitry determines one or more of the difference values are equal to or greater than a corresponding threshold, then the control circuitry reduces, late in the execution pipeline, the rate of instruction execution of computation lanes of one or more compute circuits. Further details of these techniques to reduce the voltage droop (positive or negative) of multiple compute circuits of an integrated circuit are provided in the following description of FIGS. 1-9.

Referring to FIG. 1, a generalized block diagram is shown of an apparatus 100 that manages the overshoot condition and the undershoot condition among replicated compute circuits of an integrated circuit. In the illustrated implementation, the apparatus 100 includes the control blocks 140 and at least two partitions, such as partitions 110A-110B. Although two partitions are shown, the apparatus 100 can have any number of partitions based on design requirements. In various implementations, the partition 110B is an instantiated copy of the circuitry of the partition 110A. As shown, partition 110A includes a scheduler 120A and compute circuit 130A. Similarly, partition 110B includes a scheduler 120B and compute circuit 130B. In some implementations, the functionality of the apparatus 100 is included as one die of multiple dies on a system-on-a-chip (SOC). In other implementations, the functionality of the apparatus 100 is implemented by multiple, separate dies that have been fabricated on separate silicon wafers and placed in system packaging known as multi-chip modules (MCMs).

Each of the compute circuits 130A-130B includes circuitry that performs (or “executes”) tasks (e.g., based on execution of instructions, detection of signals, movement of data, generation of signals and/or data, and so on). The control blocks 140 receive information from the compute circuits 130A-130B, and provide control information 150A-150B to the compute circuits 130A-130B. In various implementations, the compute circuits 130A-130B are capable of using the control information 150A-150B to determine a rate of instruction execution without changing the operating clock frequency. In particular, the circuitry within the compute circuits 130A-130B uses the control information 150A-150B, rather than the schedulers 120A-210B. Therefore, the latency to change the rate of instruction execution is reduced.

Other components of the apparatus 100 are not shown for ease of illustration. For example, a memory controller, one or more input/output (I/O) interface circuits, interrupt controllers, one or more phased locked loops (PLLs) or other clock generating circuitry, one or more levels of a cache memory subsystem, and a variety of other compute circuits are not shown although they can be used by the apparatus 100. In various implementations, the apparatus 100 is used in a desktop, a portable computer, a mobile device, a server, a peripheral device, or other.

In various implementations, each of the compute circuits 130A-130B is a single instruction multiple data (SIMD) circuit. The circuitry of the computation lanes 132A-132B process highly parallel data applications. Each of the computation lanes 132A-132B includes multiple lanes with each lane being an instantiation of the same circuitry that is capable of executing a thread. In some implementations, these multiple lanes within any one of the computation lanes 132A-132B operate in lockstep. In various implementations, the data flow within each of these multiple lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration.

The circuitry within a given row across the multiple lanes of the computation lanes 132A includes the same circuitry and operates on a same instruction, but different data associated with a different thread. Each data item is processed independently of other data items, but the same sequence of operations of the subroutine is used. In an implementation, the circuitry of the computation lanes 132A is a SIMD circuit that includes 64 lanes of execution. In such an implementation, the computation lanes 132A are able to simultaneously process 64 threads. In other implementations, the circuitry of the computation lanes 132A is a SIMD circuit that includes another number lanes of execution based on design requirements. By being an instantiated copy of the computation lanes 132A, the computation lanes 132B are implemented in a similar manner.

The tasks assigned to the compute circuits 130A-130B are grouped into work blocks. As used herein, a “work block” is a block of work executed in an atomic manner. In some implementations, the granularity of the work block includes a single instruction of a computer program, and this single instruction can also be divided into two or more micro-operations (micro-ops) by the apparatus 100. In other implementations, the granularity of the work block includes one or more instructions of a subroutine. A particular combination of the same instruction and a particular data item of multiple data items is referred to as a “work item.” A work item is also referred to as a thread. A number of multiple work items are grouped into a “wavefront” for simultaneous execution by multiple SIMD execution lanes of a corresponding one of the computation lanes 132A-132B. In such implementations, the work block is a “wavefront.”

In an implementation, a scheduler (not shown) within the control blocks 140 receives work blocks for execution on the computation lanes 132A-132B, and sends the assigned work blocks to the schedulers 120A-120B of the partitions 110A-110B. This scheduler in the control blocks 140 performs these assignments based on load balancing, a round-robin scheme, or another scheme. In one implementation, work blocks are wavefronts, and this scheduler retrieves the wavefronts from a buffer such as system memory. Other circuitry, such as a general-purpose central processing unit (CPU), stores the wavefronts in the buffer and sends an indication to the apparatus 100 specifying that pending wavefronts are stored in the buffer. In other implementations, this scheduler is included in another type of circuitry other than a GPU, and the work blocks are received from another type of circuitry other than a CPU.

If the schedulers 120A-120B, or a scheduler within the control blocks 140, are relied upon to change the rate of instruction execution by the computation lanes 132A-132B, voltage droop (positive or negative) could have occurred before the computation lanes 132A-132B actually changed the rate of execution. The voltage droop, ΔV, is proportional to the expression L di/dt, with L being the parasitic inductance and di/dt being the time rate of change of the current consumption. The voltage droop, ΔV, is the difference between the initial voltage and the final voltage of the shared power rail.

The overshoot condition occurs when there is negative voltage droop, and the undershoot condition occurs when there is positive voltage droop. Information regarding the change of the rate of instruction execution would need to traverse from a scheduler within the control blocks 140 to the schedulers 120A-120B, and then to the computation lanes 132A-132B via the circuitry 134. In contrast, if the circuitry 134A-134B directly receives the control information 150A-150B from the control blocks 140, then the latency to change the rate of instruction execution by the computation lanes 132A-132B reduces. Using the control information 150A-150B from the control blocks 140 in this manner and reducing the latency to change the rate of instruction execution by the computation lanes 132A-132B also reduces, or completely removes, the occurrence of voltage droop (positive or negative). In other words, using the control information 150A-150B from the control blocks 140 in this manner reduces, or completely removes, the overshoot condition and the undershoot condition.

The control blocks 140 send the control information 150A-150B to the circuitry 134A-134B. The control information 150A-150B includes parameters that control the rate of instruction execution by the computation lanes 132A-132B. The generation of the control information 150A-150B is based on feedback information from the schedulers 120A-120B. The schedulers 120A-120B monitor instruction types of instructions, such as the opcodes of instructions, of the assigned work blocks, and determine early when voltage droop is about to occur. This determination is based on the estimated amount of power consumed by execution of the monitored instruction types. This determination accounts for the time rate of change of the current consumption, or di/dt, of voltage droop. The voltage droop, ΔV, is proportional to the expression L di/dt, wherein L is the parasitic inductance and di/dt is the time rate of change of the current consumption.

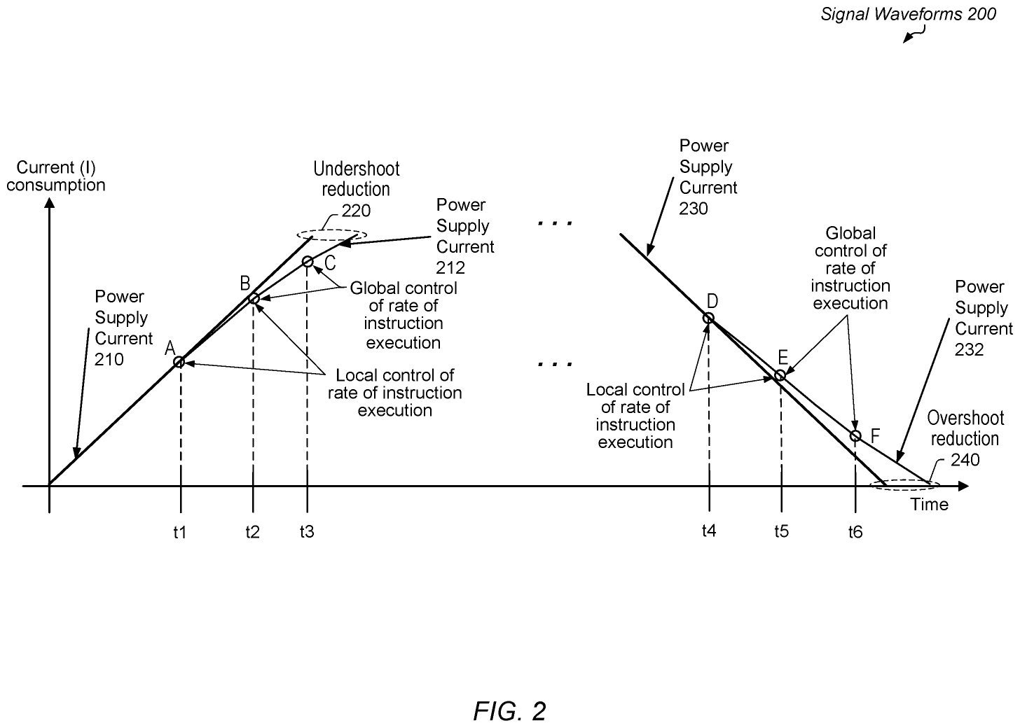

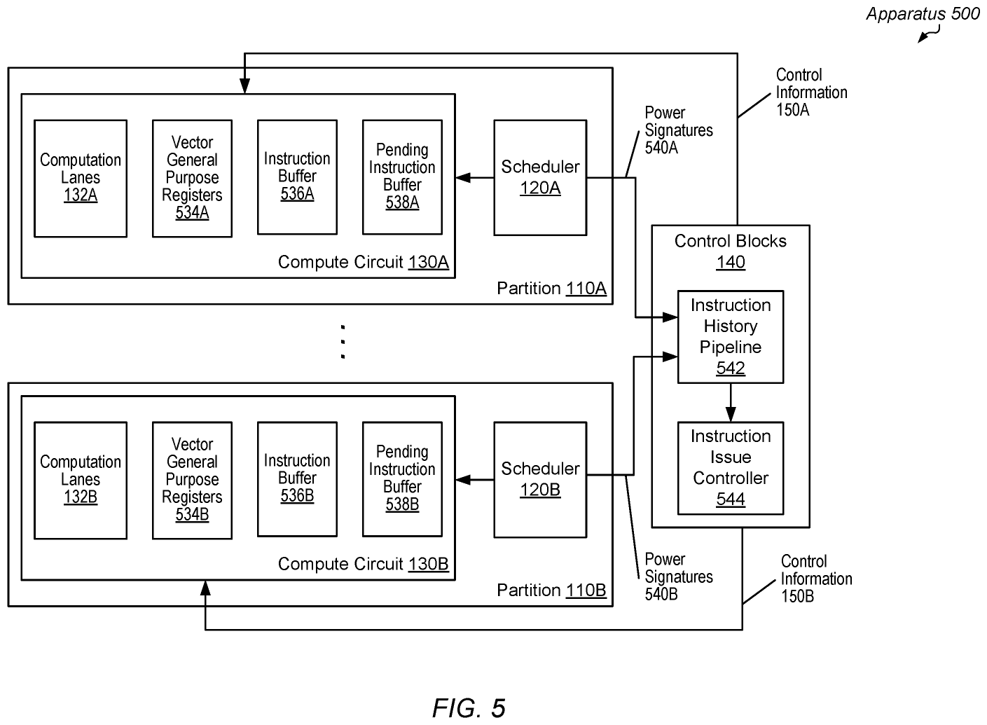

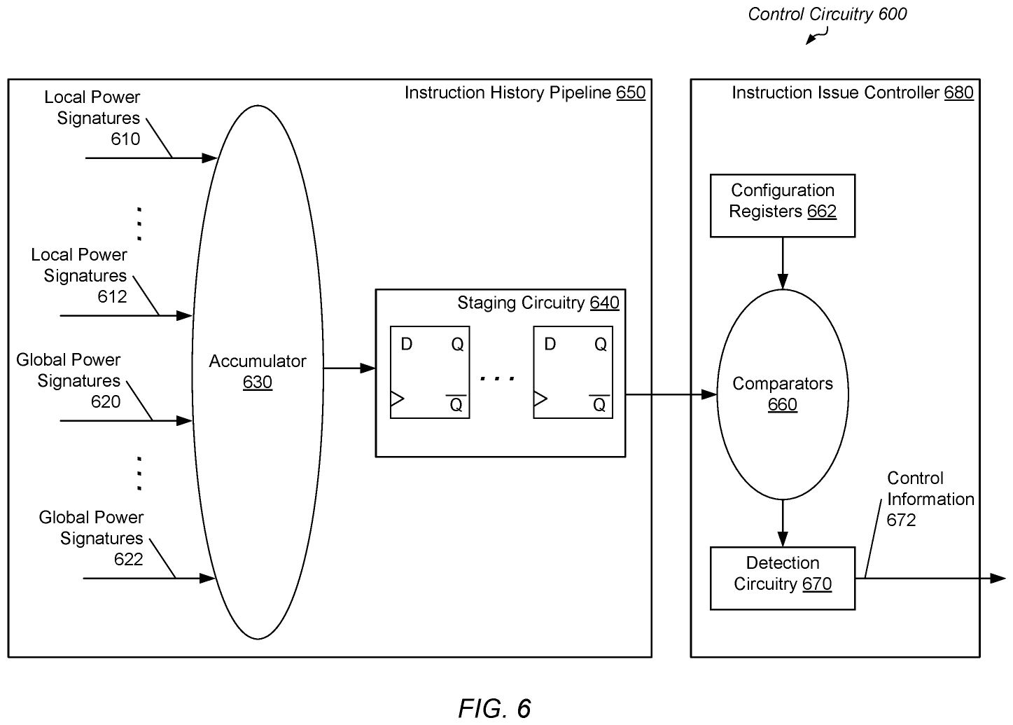

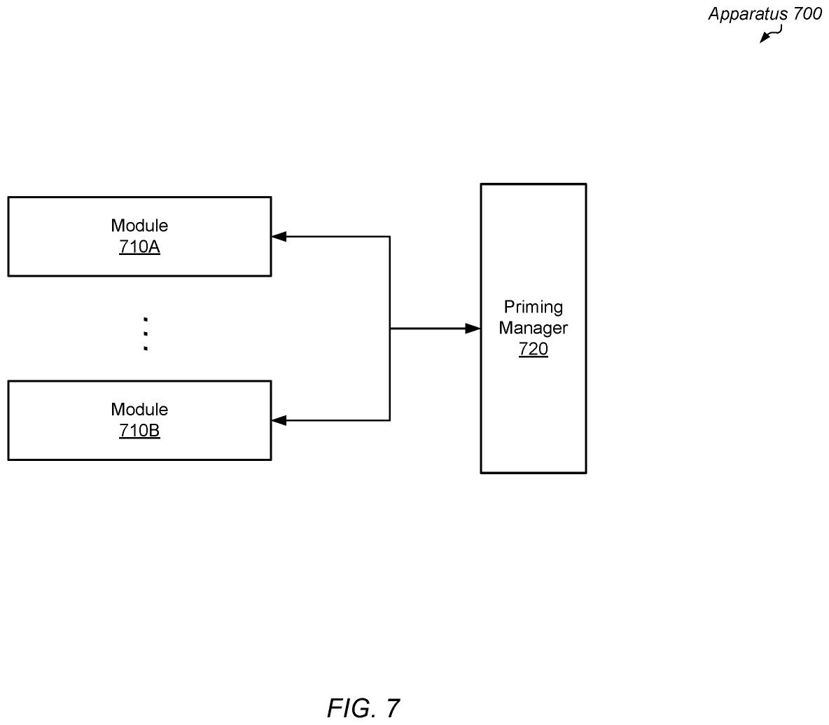

The resulting voltage droop can be positive or negative, since there are two directions for the time rate of change of the current consumption, di/dt, corresponding to the shared power rail. The power supply current can be suddenly drawn away from the power rail during the near simultaneous charging of a large number of nodes, or the power supply current can be suddenly returned to the shared power rail during the near simultaneous discharging of a large number of nodes. The overshoot condition occurs when there is negative voltage droop, and the undershoot condition occurs when there is positive voltage droop. By placing the point of changing the rate of instruction execution deep in the pipeline, such as at one of the last one to two stages of the circuitry 134A-134B, based on monitoring of instruction types early in the pipeline, such as at the schedulers 120A-120B, the apparatus 100 mitigates voltage droop (positive or negative). Further details of this voltage droop mitigation mechanism that reduced, or completely removes, the overshoot condition and the undershoot condition are provided in the description of the apparatus 500 (of FIG. 5), control circuitry 600 (of FIG. 6), and the apparatus 700 (of FIG. 7). Further details of the types of voltage droop are provided in the following description of signal waveforms 200 (of FIG. 2).

Referring to FIG. 2, a generalized block diagram is shown of signal waveforms 200 that illustrates voltage droops (positive or negative) of a power supply reference level of an integrated circuit. The signal waveforms 200 include the power supply current 210, which is an amount of current consumption over time that flows either to or from a power rail of an integrated circuit. The power supply current 210 is increasing, such as ramping up, over time. The power supply current 230 is decreasing, such as ramping down, over time. The power supply current 210 increases as the integrated circuit begins performing more work and more circuitry becomes active. In contrast, the power supply current 230 decreases as the integrated circuit begins performing less work and more circuitry becomes inactive.

When the time rate of change of the power supply current 210 or the power supply current 230 exceeds a particular magnitude for sufficient time, the resulting voltage droop can affect the setup time and the hold time of sequential elements of the integrated circuit. Examples of the sequential elements are flip-flop circuits, a variety of types of random-access memories (RAMs), content addressable memories (CAMs), and so forth. The overshoot condition affects the hold time of sequential elements, and the undershoot condition affects the setup time of sequential elements.

When the integrated circuit has an increasing workload, the simultaneous switching of a wide bus can cause a significant voltage drop of the power supply voltage on the power rail as the power supply current significantly ramps up to provide a large amount of the power supply current 210 to circuitry, such as buffers of the wide bus, connected to the power rail. The resulting voltage transient, which is also referred to as “voltage droop,” is expressed as ΔV, which is proportional to the expression L di/dt, where L is the parasitic inductance and di/dt is the time rate of change of the current consumption from the power rail. The parasitic inductance L of the power delivery network that provides the power supply voltage on the power rail reacts to reduce the time rate di/dt of the large amount of the power supply current 210.

In addition to a wide bus, the near simultaneous switching of a large number of other nodes of the integrated circuit can also consume a large amount of the power supply current 210 from the shared power rail. This type of positive voltage droop is referred to as the “undershoot” condition, since the power supply voltage level on the power rail reduces as the power supply current 210 increases. The voltage droop, ΔV, is the difference between the initial voltage and the final voltage of the shared power rail. The near simultaneous discharging of a large number of nodes, even nodes other than nodes of buses, of the integrated circuit can return a large amount of the power supply current to the shared power rail, which causes the voltage droop, ΔV, to be a large, negative value. This type of negative voltage droop is referred to as the “overshoot” condition since the power supply voltage level on the power rail increases as the power supply current returns.

Typically, mechanisms used to mitigate the undershoot condition include reducing the operating clock frequency. However, the performance decreases. Another manner to reduce the undershoot condition is placing one or more of an external capacitor between the supply leads and an on-chip capacitor between the internal supply leads. Each of these capacitances create a passive bypass that reduces the supply line oscillation due to one of external or internal inductances, but not both of the inductances. In addition, However, the internal capacitor is very large, which requires a significant portion of the chip area. This manner is undesirable when minimization of the die area is needed.

A more efficient mechanism to mitigate the overshoot condition and the undershoot condition includes the mechanism used by the apparatus 100 (of FIG. 1). This mechanism includes placing the point of changing the rate of instruction execution deep in a SIMD pipeline, such as at one of the last one to two stages of instruction buffering and source operand buffering prior to the computation lanes. The changing of the rate of instruction execution is based on the monitoring of instruction types early in the pipeline, such as at schedulers that issue instructions to the circuitry of compute circuits. When this mechanism is used, the power supply current 210 has its time rate of change decreased as shown by the power supply current 212. As shown, at the point-in-time t1 (or time t1), which is also labeled as point “A,” the power supply current 212 begins to be less than the power supply current 210. Similarly, at time t2, which is also labeled as point “B,” the power supply current 212 is less than the power supply current 210. The circuitry that is local within the apparatus and controls the rate of instruction execution affects the power supply current at times t1 and t2.

At time t3, which is also labeled as point “C,” the power supply current 212 is less than the power supply current 210. Circuitry that is external from the apparatus and controls the rate of instruction execution of other apparatuses affects the power supply current at times t2 and t3. For example, an external apparatus determines it is going to reduce its rate of instruction execution, and the external apparatus sends an indication of this reduction to one or more other apparatuses. Each of these one or more other apparatuses uses this received information to determine whether to reduce its own rate of instruction execution, and if so, by how much. The resulting difference between the power supply current 210 and the power supply current 212 is shown as the undershoot reduction 220.

When the integrated circuit has a decreasing workload, the simultaneous switching of a wide bus can cause a significant voltage increase, or overshoot voltage, of the power supply voltage on the power rail as the power supply current significantly ramps down to provide a large amount of the power supply current 230 from the circuitry, such as buffers of the wide bus, to the power rail. The parasitic inductance L of the power delivery network that provides the power supply voltage on the power rail reacts to reduce the time rate di/dt of the large amount of the power supply current 210. In addition to a wide bus, the near simultaneous switching of a large number of other nodes of the integrated circuit can also provide a large amount of the power supply current 230 to the shared power rail. This type of voltage droop is referred to as “overshoot” condition since the power supply voltage level on the power rail increases as the power supply current 230 decreases (flows from the circuitry of the integrated circuit to the power rail).

Typically, there are no mechanisms that mitigate the overshoot condition. However, when the above mechanism directed at mitigating the undershoot condition is used, the overshoot condition should also be mitigated. By monitoring instruction types early in the pipeline, such as at schedulers that issue instructions to the circuitry of compute circuits, the rate of instruction execution can be determined early in the SIMD pipeline. The determined change in the rate instruction execution can be actually set deep in the SIMD pipeline such as one or more immediately previous execution pipeline stages prior to the computation lanes beginning execution of the instructions monitored earlier in the SIMD pipeline. When this mechanism is used, the power supply current 230 has its time rate of change increased as shown by the power supply current 232. As shown, at time t4, which is also labeled as point “D,” the power supply current 232 begins to be greater than the power supply current 230. Similarly, at time t5, which is also labeled as point “E,” the power supply current 232 is greater than the power supply current 230. The circuitry that is local within the apparatus and controls the rate of instruction execution affects the power supply current at times t4 and t5.

At time t6, which is also labeled as point “F,” the power supply current 232 is greater than the power supply current 230. Circuitry that is external from the apparatus and controls the rate of instruction execution of other apparatuses affects the power supply current at times t5 and t6. The resulting difference between the power supply current 230 and the power supply current 232 is shown as the overshoot reduction 240.

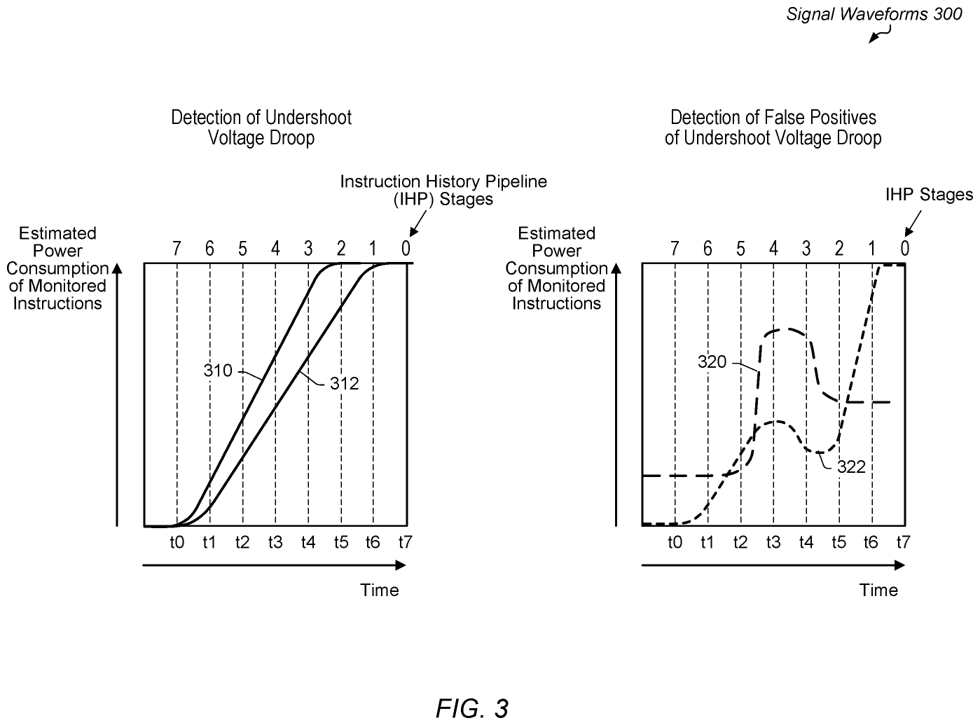

Turning now to FIG. 3, a generalized block diagram is shown of signal waveforms 300 that illustrates voltage droops (positive or negative) of a power supply reference level of an integrated circuit. The signal waveforms 300 include the signal waveforms 310, 312, 320 and 322 indicating estimated power consumption over time. An integrated circuit uses an undershoot condition and overshoot condition mitigation mechanism that monitors instructions early in a pipeline, such as at schedulers that directly issue instructions to the circuitry of compute circuits. When using the mechanism, the integrated circuit estimates (or predicts) power consumption of the later execution of these instructions. This estimation is a prediction of the later power consumption of the later execution of the same instructions if the rate of instruction execution by the computation lanes is not changed. These estimations (or predictions) of power consumption are based on at least the opcodes of the instructions. An opcode of an instruction indicates an operation to be performed by the instruction, a number of operands to be used by the instruction, and a data size of the operands to be used by the instruction. These estimations (or predictions) of power consumption based on the opcodes of instructions indicate an amount of current consumed from (or returned to) a power rail.

In some implementations, the granularity of the estimations (or predictions) of power consumption is less than the number of different opcodes. For example, in an implementation the integrated circuit supports a particular number of power bins, such as 4 power bins, and instructions belong to one of the particular number of power bins based on the opcodes. Each power bin has an associated with given amount of power consumption which can be identified by a number of power credits or otherwise. A number of power credits of a particular power bin indicates the amount of power consumed (or the amount of current drawn from a power rail) when an instruction with an opcode of the particular power bin is executed by one of the computation lanes 132A-132B. As used herein, a “power credit” can also be referred to as a “power signature.” When using the mechanism, the integrated circuit also changes the rate of instruction execution of the computation lanes 132A-132B deep in the pipeline based on the power signatures of the group of instructions that are determined from the monitoring of the instructions early in the pipeline.

The integrated circuit that implements the mechanism also maintains a history of the estimated power consumption over time. In some implementations, the integrated circuit maintains a number N of estimated power consumption values (or power signatures) where N is a positive, non-zero integer. In the illustrated implementation, the integrated circuit maintains 8 estimated power consumption values. However, in other implementations, the integrated circuit maintains another number of estimated power consumption values based on design requirements. In an implementation, the integrated circuit includes 8 pipeline stages with the stages numbered from 0 to 7 that correspond to the points in times (or times) t0 to t7. Each of the points in time corresponds to a particular time period. The time period is a particular number of clock cycles based on design requirement.

The pipeline stage 0 stores the most-recent estimated power consumption values, the pipeline stage 1 stores the next youngest estimated power consumption values, and so on. These pipeline stages belong to an instruction history pipeline (IHP). The pipeline stage 7 stores the oldest estimated power consumption values stored in the pipeline stages. As a next estimated power consumption value is determined, the previous one or more estimated power consumption values are shifted in the pipeline stages of the IHP. In the illustrated implementation, the integrated circuit had initiated execution of a new workload and has collected 8 estimated power consumption values.

After the first 8 time periods, the IHP stage labeled “7” includes the initial estimated power consumption value. The IHP stage labeled “6” includes the subsequent estimated power consumption value. The IHP stage labeled “0” includes the most-recent estimated power consumption value. The signal waveforms 310 and 312 provide examples of estimated power consumption values corresponding to an undershoot condition. In contrast, the signal waveforms 320 and 322 do not provide examples of estimated power consumption values corresponding to an undershoot condition (or any voltage droop). These estimated power consumption values increase and decrease between IHP stages. Therefore, the integrated circuit does not determine that the amount of current that flows from the power rail to the circuitry of the integrated circuit causes an undershoot condition.

In an implementation, the integrated circuit determines a difference between estimated power consumption values stored in pipeline stages labeled “4” (at time t3) and labeled “7” (at time t0). In some implementations, the integrated circuit determines an absolute value of the difference. The integrated circuit compares the difference to a threshold. In another implementation, the integrated circuit uses the estimated power consumption values stored in pipeline stages labeled “4” (at time t3) and labeled “7” (at time t0) as input values to a formula. In some implementations, the formula multiplies the estimated power consumption estimates by weights, and the weights are based on the corresponding stage of the instruction history pipeline. In other implementations, the integrated circuit uses another type of formula to determine the difference values to compare to the threshold.

The threshold is stored in a programmable configuration register. In some implementations, multiple thresholds are stored, and the integrated circuit selects one of the multiple thresholds to use in the comparison based on the presently used operating parameters of the integrated circuit. If the integrated circuit determines the difference is equal to or greater than the selected threshold, then the integrated circuit predicts an undershoot condition will occur during later execution of instructions if the rate of instruction execution by the computation lanes is not changed.

In other implementations, the integrated circuit can determine differences of estimated power consumption values between other pipeline stages of the IHP and maintain corresponding multiple thresholds, each threshold corresponding to particular operating parameters of the integrated circuit. Examples of the operating parameters of the integrated circuit are the operating clock frequency and the operating power supply voltage level. As used herein, a “P-state” is one of multiple power-performance states that include a set of operational parameters such as an operational clock frequency and an operational power supply voltage. Therefore, the integrated circuit selects one of the multiple thresholds to use in the comparison based on the presently used P-state. If any of the multiple comparisons indicates that a corresponding difference is equal to or greater than the selected threshold, then the integrated circuit predicts an undershoot condition will occur during later execution of instructions if the rate of instruction execution by the computation lanes is not changed. In response, the integrated circuit generates control information that controls the rate of instruction execution by the computation lanes, and sends this control information to one or more immediately previous execution pipeline stages prior to the computation lanes.

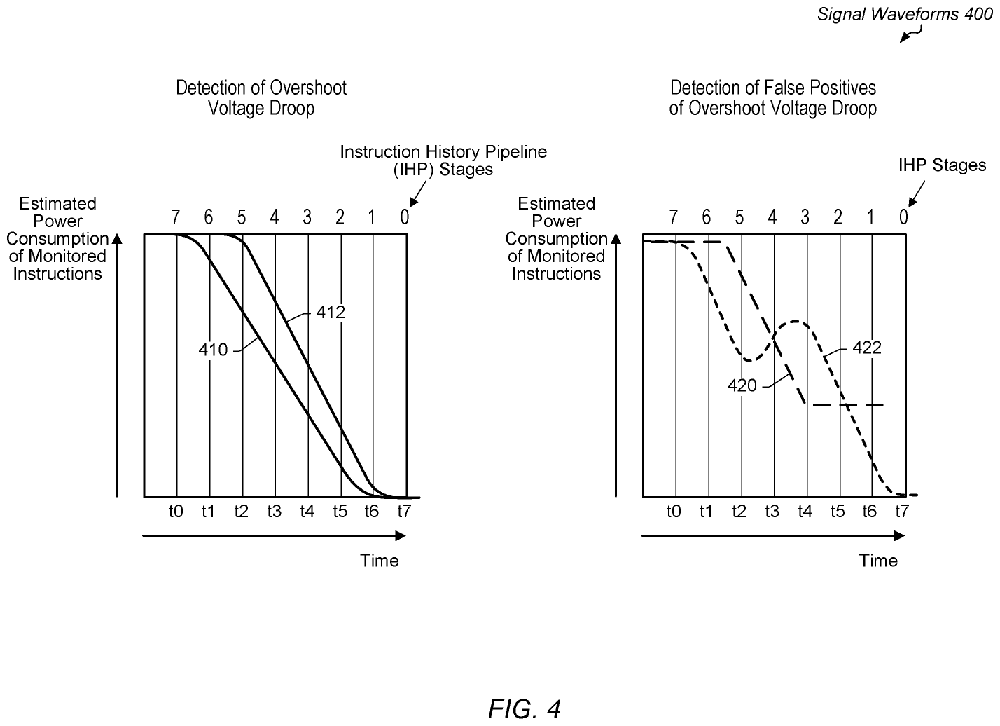

Turning now to FIG. 4, a generalized block diagram is shown of signal waveforms 400 that illustrates voltage droops (positive or negative) of a power supply reference level of an integrated circuit. The signal waveforms 400 include the signal waveforms 410, 412, 420 and 422 indicating estimated power consumption over time. An integrated circuit uses an undershoot and overshoot mitigation mechanism that monitors instruction types early in a pipeline, such as at schedulers that issue instructions to the circuitry of compute circuits. Early in a pipeline, the mechanism, based on instruction types, estimates power consumption of execution of instructions that occur late in the pipeline. The mechanism also changes the rate of instruction execution deep in the pipeline based on the estimates of power consumption that are determined from the monitoring of the instruction types early in the pipeline.

In the illustrated implementation, the integrated circuit has been executing a workload, and then a time period of low activity or no activity of the workload is reached. The time period can be due to most or all threads of a wavefront executed a branch instruction that ends execution of the current thread. The time period can also be due to execution of a barrier instruction or a wait instruction that halts (or stalls) execution of multiple or all threads of a wavefront. Additionally, the time period can be due to an actual end of execution of threads of a subroutine. As shown, the integrated circuit has collected 8 estimated power consumption values at the end of the workload. However, in other implementations, the integrated circuit maintains another number of estimated power consumption values based on design requirements. In addition, in other examples, the 8 estimated power consumption values occur prior to the end of the workload. The IHP stage labeled “0” includes the most-recent estimated power consumption value. The IHP stage labeled “1” includes the next youngest estimated power consumption value after the most-recent estimated power consumption value, and so on.

The signal waveforms 410 and 412 provide examples of estimated power consumption values corresponding to an overshoot condition. In contrast, the signal waveforms 420 and 422 provide examples of estimated power consumption values, but these estimated power consumption values do not correspond to an overshoot condition (or any voltage droop). Each of these estimated power consumption values provides an indication of an amount of current consumed from a power rail. These estimated power consumption values increase and decrease between IHP stages without large differences. Therefore, the integrated circuit does not determine that the amount of current that flows to the power rail from the circuitry of the integrated circuit causes an overshoot condition.

In various implementations, the integrated circuit determines multiple differences of estimated power consumption values between pipeline stages of the IHP and uses these differences as inputs to a formula. The integrated circuit also maintains multiple thresholds, each threshold corresponding to a particular P-state. In one implementation, the integrated circuit determines a difference between estimated power consumption values in pipeline stages labeled “6” (at time t1) and “2” (at time t5), and compares the difference to a threshold selected based on the presently used P-state. In other implementations, the integrated circuit determines an output value of the formula that receives, as input values, the estimated power consumption values in pipeline stages labeled “6” (at time t1) and “2” (at time t5). The integrated circuit compares the output value to a threshold selected based on the presently used P-state.

If any of the one or more comparisons indicates that a corresponding difference (or formula output value) is equal to or greater than a corresponding selected threshold, then the integrated circuit predicts an overshoot condition will occur during later execution of instructions if the rate of instruction execution by the computation lanes is not changed. In response, the integrated circuit generates control information that controls the rate of instruction execution by the computation lanes, and sends this control information to one or more immediately previous execution pipeline stages prior to the computation lanes. In some implementations, the control information includes indications to insert one or more “nop” instructions where each nop instruction installs a clock cycle (or a “bubble”) in the execution pipeline. In an implementation, the control information also includes indications to insert one or more instructions that do not change the operating state, and consumes a lower amount of power. One example is a move (“mov”) instruction that uses a destination operand equal to a source operand such that a data value is read from a particular register and then written back later into the particular register.

Referring to FIG. 5, a generalized block diagram is shown of an apparatus 500 that manages the overshoot condition and the undershoot condition among replicated compute circuits of an integrated circuit. Hardware, such as circuitry, described earlier are numbered identically. In the illustrated implementation, the apparatus 500 includes the control blocks 140 and the partitions 110A-110B. Although two partitions are shown, the apparatus 500 includes another number of partitions in other implementations based on design requirements. The control blocks 140 include the instruction history pipeline 542 and the instruction issue controller 544. In addition to the computation lanes 132A, the compute circuit 130A includes the vector general-purpose registers 534A, the instruction buffers 536A, and the pending instruction buffers 538A. By being an instantiated copy of the compute circuit 130A, the compute circuit 130B includes the computation lanes 132B, the vector general-purpose registers 554B, the instruction buffers 136B, and the pending instruction buffers 538B.

The computation lanes 132A-132B can be used for real-time data processing such as rendering multiple pixels, image blending, pixel shading, vertex shading, and geometry shading. Some threads, which are not video graphics rendering algorithms, still exhibit parallel data and intensive throughput. These threads have instructions which are capable of operating simultaneously with a relatively high number of different data elements (or data items). Examples of these threads are threads for scientific, medical, finance and encryption/decryption computations. The schedulers 120A-120B of the partitions 110A-110B receive work blocks for execution on the computation lanes 132A-132B. The instructions (or translated commands) of the work blocks are issued from the schedulers 120A-120B to be stored in staging buffers such as the pending instruction buffers 538A-538B. Later, the instructions are sent to the instruction buffers 536A-536B.

From the instruction buffers 536A-536B, the instructions are sent to the computation lanes 132A-132B. In other implementations, the compute circuits 130A-130B include another number of staging buffers and other types of circuit blocks between the schedulers 120A-120B and the computation lanes 132A-132B. In any of these implementations, the latency of the path from the scheduler 120A to the instruction history pipeline 542 to the instruction issue controller 544 and to the computation lanes 132A is less than the latency of the path from the scheduler 120A directly through the circuit blocks of the compute circuit 130A-such as to the pending instruction buffer 538A to the instruction buffer 536A and to the computation lanes 132A. The compute circuit 130B has a same relationship between the latencies of the paths.

The computation lanes 132A-132B read (or load) data items to be used as source operands from a corresponding one of the vector general-purpose registers 534A-554B. In various implementations, each of the vector general-purpose registers 534A-554B is organized as a register file. The vector general-purpose registers 534A-554B are implemented with one of flip-flop circuits, a random-access memory (RAM), a content addressable memory (CAM), or other. The computation lanes 132A-132B also store (or write) intermediate data items and result data items into a corresponding one of the vector general-purpose registers 534A-554B. The computation lanes 132A-132B receive one or more instructions (or micro-ops), or commands, in a clock cycle from a corresponding one of the instruction buffers 536A-536B.

As shown, for the partition 110A, each of the vector general-purpose registers 534A, the instruction buffer 536A, and the pending instruction buffer 538A is located closer to the computation lanes 132A than the scheduler 120A. A similar relationship exists in the partition 110B. In various implementations, the circuitry within the compute circuits 130A-130B uses the control information 150A-150B, rather than the schedulers 120A-120B use the control information 150A-150B. By having the compute circuits 130A-130B use the control information 150A-150B, rather than the schedulers 120A-120B, latency to change the rate of instruction execution by the computation lanes 132A-132B is reduced. In contrast, changing the rate of instruction execution at the schedulers 120A-120B, or at another scheduler within the control blocks 140, or at another scheduler located externally from the apparatus 500 increases the latency to change the rate of instruction execution by the computation lanes 132A-132B. Increasing this latency to change the rate of instruction execution reduces the effectiveness of reducing undershoot or overshoot condition.

Each of the instruction types executed by the computation lanes 132A has an associated amount of power consumed when the instruction type is executed by the computation lanes 132A. The amount of power consumed by execution of an instruction is based on the particular operation of the instruction indicated by its opcode that is performed by a computation circuit, and the reading of source operands and the writing of a destination operand found in the vector general-purpose registers (VGPRs). The amount of power consumption is based on the instruction type, and operating parameters of the computation lanes 132A, such as the operating clock frequency and the operating power supply voltage level. In various implementations, each of the multiple instruction types is assigned to a corresponding power category (or power bin) of multiple power categories (or power bins) indicating power consumption.

In an implementation, the apparatus 500 supports 4 power bins identified with identifiers 0 to 3 with 0 being associated with the smallest power consumption and 3 being associated with the largest power consumption. In some implementations, the assignments of instruction types to the 4 power bins are based on testing of the apparatus 500 in a lab environment prior to production of products using the apparatus 500. In other implementations, the assignments of instruction types to the 4 power bins are based on circuit simulations prior to semiconductor fabrication. In yet other implementations, the assignments of instruction types to the 4 power bins are based on a combination of these two approaches. In other implementations, another total number of power bins is used based on design requirements.

Each power bin includes one or more instruction types of a total number of instruction types that can be executed by the apparatus 500. Each power bin has an associated number of power credits. A number of power credits of a particular power bin indicates the amount of power consumed when an instruction of an instruction type of the particular power category is executed by one of the computation lanes 132A-132B. As described earlier, this amount of power consumed is based on the particular operation of the instruction indicated by its opcode and the accesses of operands stored in the VGPRs. As described earlier, a “power credit” can also be referred to as a “power signature.” Both the absolute values and the relative values of the power signatures among the different power bins can be assigned based on testing of the apparatus 500 in a lab environment, circuit simulations prior to semiconductor fabrication, or a combination of the two methods.

Since the actual amount of power consumed changes based on the operating parameters, such as the operating clock frequency and the operating power supply voltage level, in some implementations, the apparatus 500 selects a value for the power signature of a particular power bin based on the operating parameters. As used herein, a “P-state” is one of multiple power-performance states that include a set of operational parameters such as an operational clock frequency and an operational power supply voltage. The apparatus 500 can use one or more power signatures for each power bin based on the P-state of the apparatus 500. For a first P-state, the apparatus 500 uses a first set of power signatures for the multiple power bins. For a second P-state, the apparatus 500 uses a second set of power signatures different from the first set of power signatures for the multiple power bins.

As shown, the partition 110A sends power signatures 540A to the instruction history pipeline 542 of the control blocks 140. The power signatures 540A are power signatures of one or more instruction types scheduled to be executed later by the computation lanes 132A. Similarly, the partition 110B sends power signatures 540B to the instruction history pipeline 542 of the control blocks 140. The hardware, such as circuitry, of the instruction history pipeline 542 accumulates the power signatures 540A-540B during one or more instruction history stages. In some implementations, an instruction history pipeline stage is a clock cycle. In various implementations, the instruction history pipeline 542 generates power signatures over time similar to the signal waveforms 300 and 400 (of FIGS. 3-4). The instruction issue controller 544 includes circuitry to select thresholds based on a currently used P-state, and compare the accumulated and staged power signatures of multiple instruction history pipeline stages to the selected thresholds. The instruction issue controller 544 determines whether the accumulated and staged power signatures over time provide signal waveforms that match undershoot condition, overshoot condition, or false positives for these voltage droops.

If the instruction issue controller 544 determines the accumulated and staged power signatures over time provide signal waveforms that match undershoot condition or overshoot condition, the instruction issue controller 544 updates one or more of the control information 150A-150B to indicate changing the rate of instruction execution by one or more of the computation lanes 132A-132B. It is noted that determining whether the change in the rate of instruction execution is required is performed early in the pipelines of the partitions 110A-110B, such as at the control blocks 140. However, the actual changing of the rate of instruction execution is performed late (or deep) in the pipelines of the partitions 110A-110B, such as at the vector general-purpose registers 534A-554B or the instruction buffers 536A-536B.

The instruction issue controller 544 sends the control information 150A-150B to one of the vector general-purpose registers 534A-554B and the instruction buffers 536A-536B. The control information 150A includes parameters that control the rate of instruction execution by the computation lanes 132A. The control information 150B includes similar parameters to control the rate of instruction execution by the computation lanes 132B. In various implementations, examples of these parameters are a start time, identifiers of one or more power categories (or power bins) of power consumed when particular instruction types are executed, an updated rate of instruction execution of high-power instructions of the identified power bins, and a duration of time (or a time window). The control information 150B includes similar parameters to control the rate of instruction execution by the computation lanes 132B.

In some implementations, the indication of the start time includes a count that is to be updated by a countdown counter (or a count up counter) to indicate a particular clock cycle for starting the change of instruction execution. In another implementation, the indication of the start time includes a program counter of a particular instruction that has not yet been issued to the computation lanes 132A. If the instruction buffer 536A receives the control information 150A, then the indication of the start time accounts for the additional latency of the vector general-purpose registers 534A before the computation lanes 132A actually changes the rate of instruction execution. The identifiers of one or more power bins identifies which instruction types should have the rate of instruction execution changed. In an implementation, the apparatus 500 supports 8 power bins identified with identifiers 0 to 7 with 0 being associated with the smallest power consumption and 7 being associated with the largest power consumption. Therefore, in an implementation, each of the power bins is identified by a 3-bit value. In other implementations, another number of power bins is supported by another number of bits based on design requirements.

In an implementation, the control information 150A indicates instructions with instruction types categorized as providing power consumption in the power bins 5 and higher have the rate of instruction execution reduced. Reducing the rate of instruction execution is also referred to as “throttling” instruction execution. Instructions with instruction types categorized as providing power consumption in the power bins 4 and lower do not have the rate of instruction execution changed. The apparatus 500 supports the 8 power bins and the control information 150A indicates instructions with instruction types of the power bins 5-7 should have instruction execution reduced by the computation lanes 132A. The control information 150A also includes an indication specifying a percentage of time to stall instructions identified as being in the identified power bins 5-7 that should have the rate of instruction execution changed.

In some implementations, a rate of 20% indicates one of every five instructions of the instruction types 5-7 will have a stall clock cycle (or a “bubble”) inserted in the pipeline. In another implementation, a rate of 80% is used to indicate every four of five instructions of the instruction types 5-7 will not have a stall cycle inserted during instruction execution, but one instruction of every five instructions of the instruction types 5-7 will have a stall clock cycle inserted. Other types of indications are possible and contemplated for specifying a percentage of time to stall instructions identified as being in the identified power bins 5-7 that should have the rate of instruction execution changed.

Additionally, the control information 150A includes an indication of a duration of time (or a time window) specifying the time period when the rate of instruction execution of instructions with instruction types of the power bins 5-7 should be changed. This indication can be specified as a number of clock cycles. A countdown counter (or a count up counter) can be used to monitor this duration of time in one of the vector general-purpose registers 534A-554B and the instruction buffers 536A-536B. Although the control information 150B includes parameters similar to the parameters of the control information 150A, the control information 150B can use different values for these parameters.

Further, in some implementations, the instruction issue controller 544 also receives status information from one or more other apparatuses. This status information indicates a number of compute circuits in these other apparatuses that have the rate of instruction execution changed, and if any, details of the changes. The details include one or more of the start time, identifiers of one or more power bins, an updated rate of instruction execution of high-power instructions of the identified power bins, and a duration of time (or a time window). The instruction issue controller 544 uses this additional information to adjust the control information 150A-150B. In some implementations, each of the apparatus 500 and other external apparatuses is a shader circuit within a shader array. The shader array is one of multiple shader arrays of a GPU. In other implementations, each of the apparatus 500 and other external apparatuses is another type of circuitry within an integrated circuit.

Turning now to FIG. 6, a generalized block diagram is shown of control circuitry 600 that manages the overshoot condition and the undershoot condition among replicated compute circuits of an integrated circuit. In the illustrated implementation, the control circuitry 600 includes the instruction history pipeline 650 and the instruction issue controller 680. The control circuitry 600 receives power signatures, such as one or more of the local power signatures 610-612 and the global power signatures 620-622, and generates the control information 672 to local compute circuits. The control information 672 includes one or more of the start time, identifiers of one or more power bins, an updated rate of instruction execution of high-power instructions of the identified power bins, and a duration of time (or a time window).

The instruction history pipeline 650 includes the accumulator 630 and the staging circuitry 640. The accumulator 630 receives local power signatures 610-612 from local partitions, each with a local compute circuit. In an implementation, each of the local partitions includes a scheduler that identifies a corresponding power bin for one or more instructions to be issued to a compute circuit. The circuitry of the scheduler accumulates the power signatures of these one or more instructions based on the corresponding power bins, and sends the accumulated power signature as one of the local power signatures 610-612. In another implementation, the scheduler sends identifiers of the power bins of the one or more instructions to the instruction history pipeline 650, and the accumulator 630 determines the accumulated power signature. In yet another implementation, the scheduler sends the opcodes of the one or more instructions to the instruction history pipeline 650. The accumulator 630 then determines the accumulated power signature based on determining the corresponding power bins of the received opcodes.

In some implementations, the accumulator 630 also receives global power signatures 620-622 from other apparatuses. In an implementation, the accumulator 630 combines the global power signatures 620-622 with the local power signatures 610-612 as a weighted sum. In another implementation, the accumulator 630 generates two output values with a first value being the total accumulation of the local power signatures 610-612. A second value is the total accumulation of the global power signatures 620-622. In some implementations, the accumulator 630 uses one of a variety of formulas besides a weighted sum to generate one or more power signatures to send to the staging circuitry 640.

In yet another implementation, the accumulator 630 does not receive the global power signatures 620-622 from other apparatuses (other integrated circuits). Rather, the instruction issue controller 680 receives status information from other apparatuses, and uses this information to generate the control information 672. In any of these implementations, the instruction issue controller 680 further reduces the rate of instruction execution at the computation lanes of compute circuits when indications are present of reductions of the rate instruction execution in other apparatuses.

The staging circuitry 640 receives at least a local accumulated value of power signatures from the accumulator 630. The staging circuitry 640 includes storage elements that support maintaining a number N of accumulated power signatures where N is a positive, non-zero integer. In an implementation, the staging circuitry 640 maintains 8 accumulated power signatures as shown earlier in the signal waveforms 300-400 (of FIGS. 3-4). In other implementations, the value N is another positive, non-zero integer based on design requirements. Each of the accumulated power signatures is an estimated power consumption of monitored instructions stored in a scheduler that have not yet been issued. The storage elements of the staging circuitry 640 are implemented with one of a variety of types of flip-flop circuits, a first-in-first-out (FIFO) buffer, or other. The staging circuitry 640 shifts the accumulated power signatures each clock cycle.

The comparators 660 receive accumulated power signatures of one or more of the N stages of the staging circuitry 640, and compares them to predict whether an undershoot condition or an overshoot condition could occur. In various implementations, the comparators 660 determines multiple differences of estimated power consumption values between pipeline stages of the staging circuitry 640. The instruction issue controller 680 includes programmable configuration registers 662. The instruction issue controller 680 maintains multiple thresholds in the programmable configuration registers 662, each threshold corresponding to a particular P-state. In one implementation, the comparators 660 determine a difference between estimated power consumption values in a first pipeline stage and a second pipeline stage different from the first pipeline stage of the staging circuitry 640. The comparators 660 compares the difference to a threshold selected based on the presently used P-state.

If the detection circuitry 670 determines that any of the one or more comparisons indicates that a corresponding difference is equal to or greater than a corresponding selected threshold, then the detection circuitry 670 predicts an undershoot condition or an overshoot condition will occur during later execution of instructions if the rate of instruction execution by the computation lanes is not changed. In response, the detection circuitry 670 generates control information 672 that controls the rate of instruction execution by the computation lanes, and sends this control information to one or more immediately previous execution pipeline stages prior to the computation lanes. Examples of parameters included in the control information 672 are a start time, identifiers of one or more power bins to control, an updated rate of instruction execution of high-power instructions of the identified power bins, and a duration of time (or a time window).

Turning now to FIG. 7, a generalized block diagram is shown of an apparatus 700 that manages the overshoot condition and the undershoot condition among replicated compute circuits of an integrated circuit. The apparatus 700 includes multiple modules 710A-710B and the priming manager 710. In some implementations, each of the modules 710A-710B includes the circuitry of the apparatus 500. In an implementation, each of the modules 710A-710B is a shader circuit and the apparatus 700 is a shader array. In various implementations, the priming manager 720 includes control circuitry that updates, based on an upcoming new P-state, one or more of thresholds and power consumption values corresponding to power bins. The priming manager 720 sends these updated values to the modules 710A-710B to be stored in programmable configuration registers.

In some implementations, the priming manager 720 includes control circuitry that receives accumulated power signatures from the modules 710A-710B, and determines changes to the rates of instruction execution of computation lanes within the modules 710A-710B. In other implementations, the control circuitry of the priming manager 720 receives indications of changes to the rates of instruction execution of computation lanes within the modules 710A-710B, and determines further changes to these rates of instruction execution. For example, the priming manager 720 further reduces these rates of instruction execution when the priming manager 720 determines a number of modules 710A-710B that have reduced the rate of instruction execution of computation lanes is equal to or greater than a threshold. Other possible scenarios are possible and contemplated to be detected by the control circuitry of the priming manager 720 that causes further changes to the rates of instruction execution of computation lanes within the modules 710A-710B.

As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet are placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated functional blocks within the single, monolithic semiconductor die.

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface functional block does not require process parameters of a semiconductor manufacturer's expensive process that provides the fastest devices and smallest geometric dimensions. With separate chiplets, designers can add or remove chiplets for particular integrated circuits to readily create products for a variety of performance categories. In contrast, an entire new silicon wafer must be fabricated for a different product when single, monolithic dies are used. It is possible and contemplated that the compute circuits and apparatuses illustrated in FIGS. 1, 5, 7 and 9 are implemented as chiplets as well.

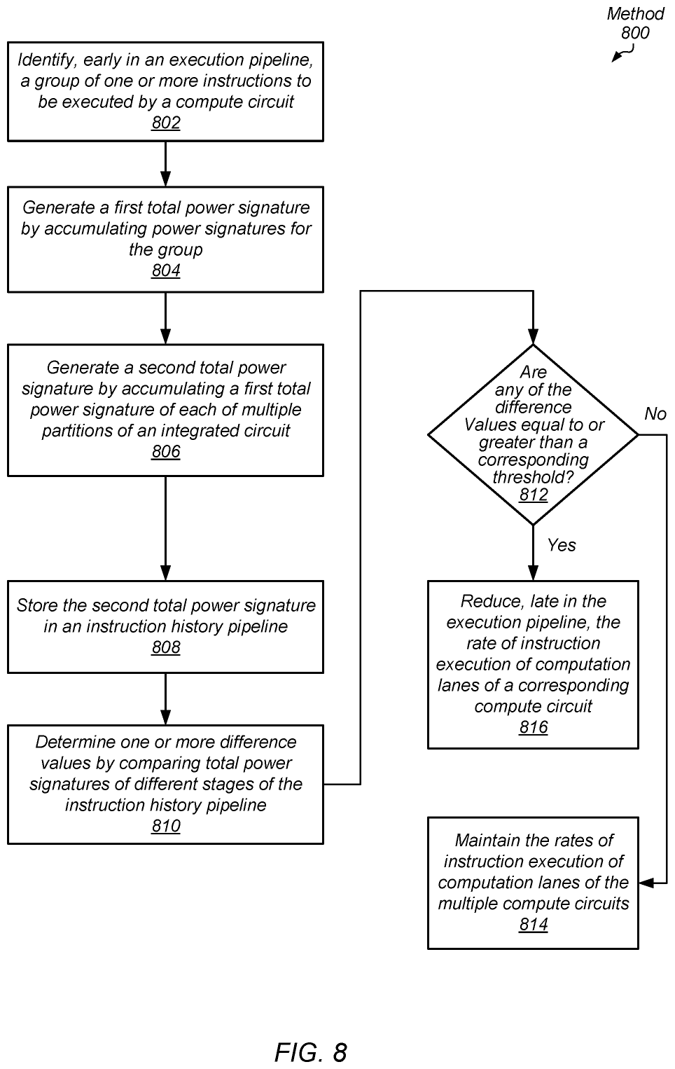

Referring now to FIG. 8, a generalized block diagram is shown of a method 800 for efficiently managing the overshoot condition and the undershoot condition of multiple compute circuits of an integrated circuit. For purposes of discussion, the steps in this implementation are shown in sequential order. However, in other implementations some steps occur in a different order than shown, some steps are performed concurrently, some steps are combined with other steps, and some steps are absent.

An integrated circuit includes multiple, replicated compute circuits, each with the circuitry of multiple lanes of execution. The integrated circuit also includes control circuitry that changes the rate of instruction execution of the computation lanes at the end of execution pipelines based on instruction types of instructions at the start of the execution pipelines. The control circuitry identifies, early in an execution pipeline, such as at the start of the execution pipeline, a group of one or more instructions to be executed by a compute circuit (block 802). The control circuitry generates a first total power signature by accumulating power signatures for the group (block 804). The control circuitry generates a second total power signature by accumulating a first total power signature of each of multiple partitions of an integrated circuit (block 806). The control circuitry stores the second total power signature in an instruction history pipeline (block 808).

The control circuitry determines one or more difference values by comparing total power signatures of different stages of the instruction history pipeline (block 810). If the control circuitry determines none of the difference values are equal to or greater than a corresponding threshold (“no” branch of the conditional block 812), then the control circuitry maintains the rates of instruction execution of computation lanes of the multiple compute circuits (block 814). If the control circuitry determines one or more of the difference values are equal to or greater than a corresponding threshold (“yes” branch of the conditional block 812), then the control circuitry reduces, late in the execution pipeline, the rate of instruction execution of computation lanes of a corresponding compute circuit (block 816). In various implementations, the control circuitry generates control information such as the control information 150A-150B (of FIGS. 1 and 5), and sends the control information to a pipeline stage of the execution pipeline immediately prior to the pipeline stage that includes the computation lanes.

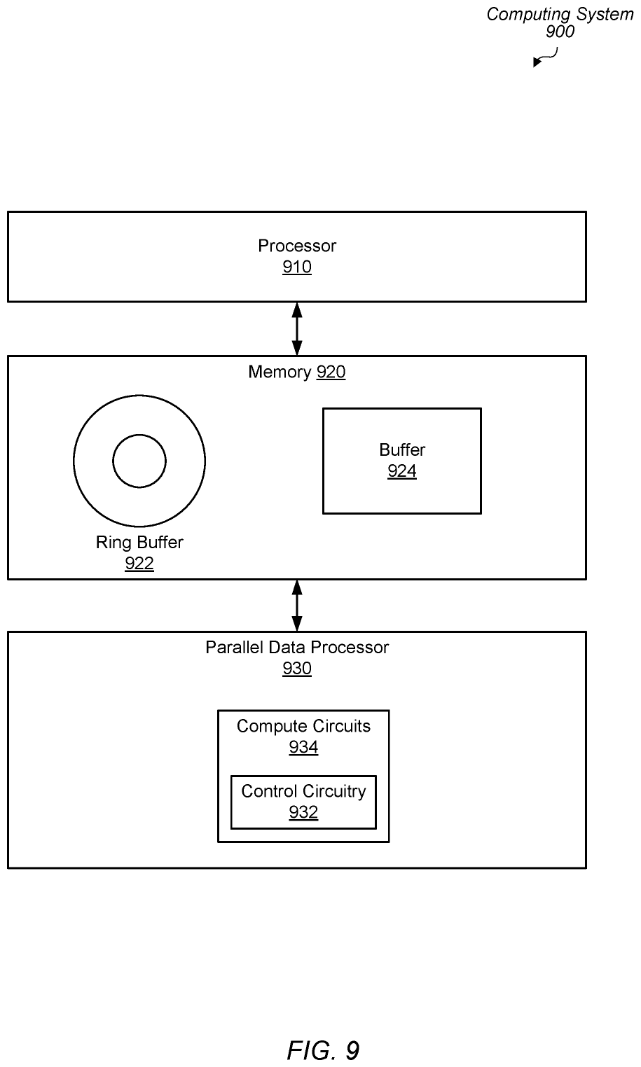

Turning now to FIG. 9, a generalized block diagram is shown of a computing system 900 that efficiently manages the overshoot condition and the undershoot condition of multiple execution pipelines of an integrated circuit. As shown, the computing system 900 includes a processor 910, a memory 920 and a parallel data processor 930. In some implementations, the functionality of the computing system 900 is included as components on a single die, such as a single integrated circuit. In other implementations, the functionality of the computing system 900 is included as multiple dies on a system-on-a-chip (SOC). In other implementations, the functionality of the computing system 900 is implemented by multiple, separate dies that have been fabricated on separate silicon wafers and placed in system packaging known as multi-chip modules (MCMs). In various implementations, the computing system 900 is used in a desktop, a portable computer, a mobile device, a server, a peripheral device, or other.

The circuitry of the processor 910 processes instructions of a predetermined algorithm. The processing includes fetching instructions and data, decoding instructions, executing instructions, and storing results. In one implementation, the processor 910 uses one or more processor cores with circuitry for executing instructions according to a predefined general-purpose instruction set architecture (ISA). In various implementations, the processor 910 is a general-purpose central processing unit (CPU). The parallel data processor 930 uses one or more processor cores with a relatively wide single instruction multiple data (SIMD) micro-architecture to achieve high throughput in highly data parallel applications. In an implementation, the parallel data processor 930 is a graphics processing unit (GPU). In other implementations, the parallel data processor 930 is another type of processor.

In various implementations, the compute circuits 934 use computation lanes with the circuitry of multiple lanes of execution. The control circuitry 932 changes the rate of instruction execution of the computation lanes at the end of execution pipelines based on instruction types of instructions at the start of the execution pipelines. In various implementations, the control circuitry 932 includes the functionality of the control circuitry 600 (of FIG. 6) and performs steps described earlier to avoid voltage droop. In various implementations, the work blocks, here, are wave fronts (or waves) of multiple work items. The parallel data processor 930 is efficient for data parallel computing found within loops of applications, such as in applications for manipulating, rendering, and displaying computer graphics. In such cases, each of the data items of a wave front is a pixel of an image. The applications can also include molecular dynamics simulations, finance computations, neural network training, and so forth. The highly parallel structure of the parallel data processor 930 makes it more effective than the general-purpose structure of the processor 910.

In various implementations, threads are scheduled on one of the processor 910 and the parallel data processor 930 in a manner that each thread has the highest instruction throughput based at least in part on the runtime hardware resources of the processor 910 and the parallel data processor 930. In some implementations, some threads are associated with general-purpose algorithms, which are scheduled on the processor 910, while other threads are associated with parallel data computationally intensive algorithms such as video graphics rendering algorithms, which are scheduled on the parallel data processor 930. The compute circuits 934 can be used for real-time data processing such as rendering multiple pixels, image blending, pixel shading, vertex shading, and geometry shading. Some threads, which are not video graphics rendering algorithms, still exhibit parallel data and intensive throughput. These threads have instructions which are capable of operating simultaneously with a relatively high number of different data elements (or data items). Examples of these threads are threads for scientific, medical, finance and encryption/decryption computations.

To change the scheduling of the above computations from the processor 910 to the parallel data processor 930, software development kits (SDKs) and application programming interfaces (APIs) were developed for use with widely available high-level languages to provide supported function calls. The function calls provide an abstraction layer of the parallel implementation details of the parallel data processor 930. The details are hardware specific to the parallel data processor 930 but hidden to the developer to allow for more flexible writing of software applications. The function calls in high level languages, such as C, C++, FORTRAN, and Java and so on, are translated to commands which are later processed by the hardware in the parallel data processor 930. Although a network interface is not shown, in some implementations, the parallel data processor 930 is used by remote programmers in a cloud computing environment.

A software application begins execution on the processor 910. Function calls within the application are translated to commands by a given API. The processor 910 sends the translated commands to the memory 920 for storage in the ring buffer 922. The commands are placed in groups referred to as command groups. In some implementations, the processor 910 and the parallel data processor 930 use a producer-consumer relationship, which is also be referred to as a client-server relationship. The processor 910 writes commands into the ring buffer 922. Circuitry of a controller (not shown) of the parallel data processor 930 reads the commands from the ring buffer 922. In some implementations, the controller is a command processor of a GPU. The controller sends work blocks to the scheduler, which assigns work blocks to the compute circuits 934. By doing so, the parallel data processor 930 processes the commands, and writes result data to the buffer 924. The processor 910 is configured to update a write pointer for the ring buffer 922 and provide a size for each command group. The parallel data processor 930 updates a read pointer for the ring buffer 922 and indicates the entry in the ring buffer 922 at which the next read operation will use.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
generate a total power consumption estimate based on one or more instructions to be executed by each of a plurality of execution pipelines, each of the plurality of execution pipelines comprising a plurality of computation lanes; and
change a rate of instruction execution of the plurality of computation lanes of at least one of the plurality of execution pipelines, in response to a difference between the total power consumption estimate and one of N previous power consumption estimates exceeding a threshold.

2. The apparatus as recited in claim 1, wherein the circuitry is further configured to generate control information to direct the rate of instruction execution of the plurality of computation lanes, wherein the control information comprises a start time that indicates when to begin the change in the rate of execution.

3. The apparatus as recited in claim 2, wherein the circuitry is further configured to:
determine a duration of time for changing the rate of instruction execution of the plurality of computation lanes; and
insert the duration of time in the control information.

4. The apparatus as recited in claim 1, wherein the total power consumption estimate corresponds to a first stage of the plurality of execution pipelines, and the change in rate of execution corresponds to a second stage later than the first stage.

5. The apparatus as recited in claim 2, wherein the circuitry is further configured to insert in the control information an identification of instructions classified as corresponding to high-power instructions.

6. The apparatus as recited in claim 2, wherein the circuitry is further configured to classify a given instruction as corresponding to a high-power instructions, responsive to execution of the given instruction.

7. The apparatus as recited in claim 6, wherein the circuitry is further configured to insert an identification of one or more of a plurality of power bins in the control information.

8. A method, comprising:
generating a total power consumption estimate based on one or more instructions to be executed by each of a plurality of execution pipelines, each of the plurality of execution pipelines comprising a plurality of computation lanes; and
changing a rate of instruction execution of the plurality of computation lanes of at least one of the plurality of execution pipelines, in response to a difference between the total power consumption estimate and one of N previous power consumption estimates exceeding a threshold.

9. The method as recited in claim 8, further comprising generating control information to direct the rate of instruction execution of the plurality of computation lanes, wherein the control information comprises a start time that indicates when to begin the change in the rate of execution.

10. The method as recited in claim 9, further comprising:
determining a duration of time for changing the rate of instruction execution of the plurality of computation lanes; and
inserting the duration of time in the control information.

11. The method as recited in claim 9, wherein the total power consumption estimate corresponds to a first stage of the plurality of execution pipelines, and the change in rate of execution corresponds to a second stage later than the first stage.

12. The method as recited in claim 9, inserting in the control information an identification of instructions classified as corresponding to high-power instructions.

13. The method as recited in claim 9, further comprising classifying a given instruction as corresponding to a high-power instructions, responsive to execution of the given instruction.

14. The method as recited in claim 13, further comprising inserting an identification of one or more of a plurality of power bins in the control information.

15. A computing system comprising:
a plurality of chiplets, each comprising a plurality of execution pipelines; and
a processor configured to assign workloads to the plurality of chiplets; and
wherein circuitry of a given chiplet of the plurality of chiplets is configured to:
generate a total power consumption estimate based on one or more instructions at a first stage of each of the plurality of execution pipelines;
change a rate of instruction execution of at least one execution pipeline of the plurality of the execution pipelines at a second stage, later than the first stage, in response to a difference between the total power consumption estimate and one of N previous power consumption estimates exceeding a threshold.

16. The computing system as recited in claim 15, wherein the circuitry is further configured to generate control information to direct the rate of instruction execution of the plurality of execution pipelines, wherein the control information comprises a start time that indicates when to begin the change in the rate of execution.

17. The computing system as recited in claim 16, wherein the circuitry is further configured to:
determine a duration of time for changing the rate of instruction execution of the plurality of execution pipelines; and
insert the duration of time in the control information.

18. The computing system as recited in claim 16, wherein the circuitry is further configured to determine a rate of instruction execution to insert in the control information based on operating parameters of the plurality of chiplets.

19. The computing system as recited in claim 16, wherein the circuitry is further configured to insert, in the control information, an identification of instructions classified as corresponding to high-power instructions.

20. The computing system as recited in claim 16, wherein the circuitry is further configured to classify a given instruction as corresponding to a power bin of a plurality of power bins, wherein the power bin indicates an amount of power consumed by the plurality of chiplets when the plurality of execution pipelines executes the given instruction.
